(19) United States
(12) Patent Application Publication
(10) Pub. No.: US 2025/0229534 A1
(43) Pub. Date: Jul. 17, 2025

(54) RECORDING ELEMENT SUBSTRATE AND LIQUID EJECTION DEVICE

(71) Applicant: CANON KABUSHIKI KAISHA, Tokyo (JP)

(72) Inventor: KEIJI WATANABE, Kanagawa (JP)

(21) Appl. No.: 19/006,381

(22) Filed: Dec. 31, 2024

(30) Foreign Application Priority Data
Jan. 17, 2024 (JP) 2024-005107

(51) Int. Cl. B41J 2/14; B41J 2/045; B41J 2/175

(52) U.S. Cl. CPC B41J 2/1433; B41J 2/04525; B41J 2/175; B41J 2/04586

(57) ABSTRACT

A recording element substrate includes a substrate, an orifice plate stacked on the substrate and having a liquid chamber which stores liquid between the substrate and the orifice plate, the orifice plate having an ejection port for ejecting the liquid in the liquid chamber, and an energy generation element provided on the substrate and configured to generate energy for ejecting the liquid stored in the liquid chamber, and the orifice plate is provided with an opening which is different from the ejection port and a flexible member which seals the opening.

### BACKGROUND OF THE INVENTION

### Field of the Invention

The present invention relates to a recording element substrate and a liquid ejection device.

### Description of the Related Art

A liquid ejection device using an inkjet method is configured to eject liquid from the ejection port of a liquid ejection head and adhere the liquid to a target medium. At the time, the liquid ejection head ejects liquid by using the pressure wave generated in a pressure chamber by a driving unit, and various methods can be employed for the driving means including utilizing a piezoelectric element, a heating element, and electrostatic force. When ejecting liquid using any of these methods, crosstalk may occur, leading to ejection failures. Crosstalk refers to the phenomenon where pressure fluctuations are caused due to the liquid ejection, and the pressure fluctuations propagate through the liquid flow path to other pressure chambers, which affects the ejection characteristic.

In order to reduce the effect of such crosstalk, methods using dampers and delay control that shifts the timing of the ejection may be used. For example, Japanese Patent Application Publication No. 2021-185050 proposes a liquid ejection head having a damper structure. In the liquid ejection head disclosed in Japanese Patent Application Publication No. 2021-185050, a compliance substrate that can be deformed is formed in part of the liquid flow path in order to attenuate the pressure wave generated in the pressure chamber. The compliance substrate is composed of a flexible member or a combination of a metal member and a flexible member because the more deformable the substrate is, the higher its ability to attenuate the pressure wave becomes.

### SUMMARY OF THE INVENTION

When using a damper structure that includes a compliance substrate that deforms as described above, the compliance substrate has to be configured to resist detachment from the recording element substrate attributable to the load repeatedly applied during ejection, particularly under the influence of thermal stress. More specifically, if there is a difference in the linear expansion coefficient between the compliance substrate and the recording element substrate, the compliance substrate may come off due to the load applied by the effect of thermal stress.

The invention has been made in view of the foregoing, and it is an object of the present invention to provide a technical feature to suppress the detachment of a deformable flexible member in a configuration in which the deformable flexible member is used for a recording element substrate used in a liquid ejection head in order to reduce load.

The present invention provides a recording element substrate comprising:
a substrate;
an orifice plate stacked on the substrate and having a liquid chamber which stores liquid between the substrate and the orifice plate, the orifice plate having an ejection port for ejecting the liquid in the liquid chamber; and
an energy generation element provided on the substrate and configured to generate energy for ejecting the liquid stored in the liquid chamber, wherein
the orifice plate is provided with an opening which is different from the ejection port, and a flexible member which seals the opening.

The present invention also provides a liquid ejection device configured to perform recording on a recording medium by ejecting liquid using a recording element substrate, the recording element substrate comprising:
a substrate;
an orifice plate stacked on the substrate and having a liquid chamber which stores liquid between the substrate and the orifice plate, the orifice plate having an ejection port for ejecting the liquid in the liquid chamber; and
an energy generation element provided on the substrate and configured to generate energy for ejecting the liquid stored in the liquid chamber, wherein
the orifice is provided with an opening which is different from the ejection port, and a flexible member which seals the opening.

According to the present invention, in a configuration in which a deformable flexible member is used for a recording element substrate used in a liquid ejection head in order to reduce load, a technical feature to suppress the detachment of the deformable flexible member can be provided.

Further features of the present invention will become apparent from the following description of exemplary embodiments with reference to the attached drawings.

### BRIEF DESCRIPTION OF THE DRAWINGS

FIG. 1 is a perspective view of a recording element substrate;

FIGS. 2A and 2B are an enlarged view and a plan view of a substrate upper part in a conventional recording element substrate;

FIGS. 3A and 3B are an enlarged view and a plan view of a substrate upper part in a recording element substrate according to a first embodiment;

FIGS. 4A to 4C are enlarged views and a plan view of a substrate upper part of another recording element substrate according to the first embodiment;

FIGS. 5A and 5B are an enlarged view and a plan view of a substrate upper part of a recording element substrate according to a second embodiment;

FIGS. 6A and 6B are an enlarged view and a plan view of a substrate upper part of another recording element substrate according to the second embodiment;

FIGS. 7A and 7B are an enlarged view and a plan view of a substrate upper part of a recording element substrate according to a third embodiment;

FIGS. 8A and 8B are an enlarged view and a plan view of a substrate upper part of another recording element substrate according to the third embodiment;

FIGS. 9A and 9B are an enlarged view and a plan view of a substrate upper part of a recording element substrate according to a fourth embodiment;

FIGS. 10A to 10D are views for illustrating a process flow described in conjunction with a first example;

FIGS. 11A to 11D are views for illustrating the continuation of the process flow described in conjunction with the first example;

FIGS. 12A to 12D are views for illustrating the process flow described in conjunction with a second example; and

FIG. 13 is a schematic view of a liquid ejection device.

### DESCRIPTION OF THE EMBODIMENTS

With reference to the drawings, preferred embodiments of the present invention will be described in detail by way of illustration. However, unless otherwise specified, the dimensions, materials, shapes, relative arrangement, and other aspects of the elements in the description of the embodiments are not intended to limit the scope of the present invention to those described. Unless stated otherwise, in the following description, the materials, shapes, and other aspects of the elements described once in the following remain the same as initially described. As for any structures or steps that are not specifically illustrated or described, well-known techniques or publicly known techniques in the field of art may be applied. Furthermore, the present invention is not limited to these embodiments, and all the combinations of the features according to the described embodiments are not necessarily essential for the solutions to be provided by the present invention.

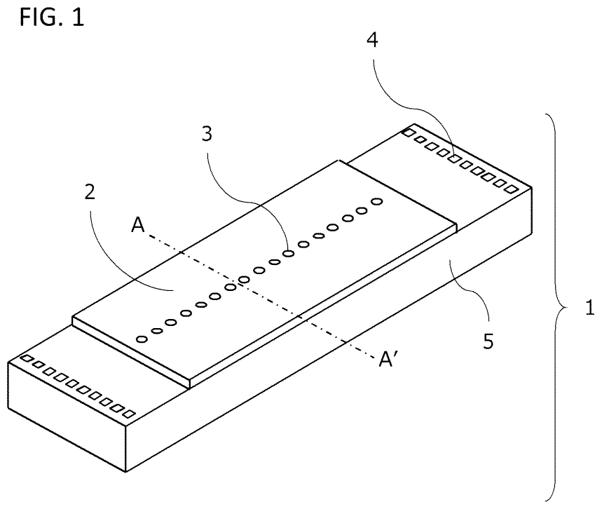

FIG. 1 is a schematic perspective view of an example of a recording element substrate 1. The recording element substrate 1 according to the present invention shown in FIG. 1 includes a substrate 5 and an orifice plate 2 stacked thereon. The orifice plate 2 includes an ejection port 3 used to eject liquid such as ink. An electrical connection 4 for connection to an electrical wiring board is formed on the substrate 5.

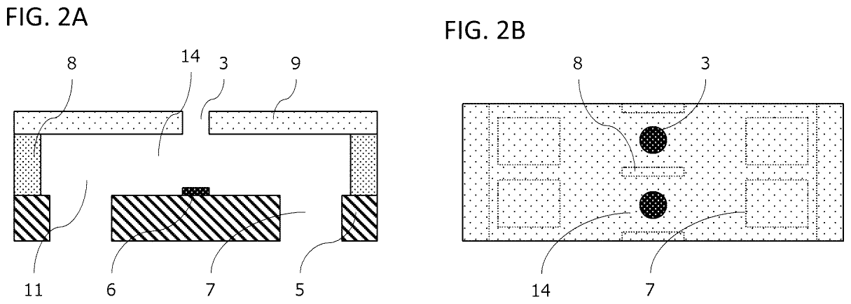

FIG. 2A is an enlarged view of the substrate upper part of a conventional recording element substrate taken along A-A′ in FIG. 1, and FIG. 2B is a plan view of the recording element substrate. An energy generation element 6 that generates energy for ejecting liquid is provided on the surface of the substrate 5. The energy generation element 6 has for example a thermoelectric conversion element or a piezoelectric element. For example, wirings (not shown) for driving the energy generation element 6 may be provided on the surface of the substrate 5. The energy generation element 6 and a pressure chamber 14 are formed corresponding to the position of the ejection port 3.

The orifice plate 2 is composed of a first resin layer 8 and a second resin layer 9 and has a liquid flow path 11 in communication with the ejection port 3. The first resin layer 8 is provided upright on the substrate 5 to form side walls. The second resin layer 9 is supported by the first resin layer 8 to oppose the substrate 5 and forms the top surface on which the ejection port 3 is formed. The substrate 5 is provided with a liquid supply port 7 for supplying ink, for example, to the liquid flow path 11. The liquid is first supplied for example from an external tank to the liquid flow path 11 via the liquid supply port 7 and then supplied from the liquid flow path 11 to the individual pressure chambers 14. The pressure chamber 14 is a space capable of storing liquid, formed corresponding to each ejection port 3 (and each energy generation element 6) and is also referred to as a liquid chamber. The ejection port 3 is provided on the upper part of the pressure chamber 14 as shown in the figure, i.e., on the side of the orifice plate 2 opposite to the side opposed to the substrate 5.

### First Embodiment

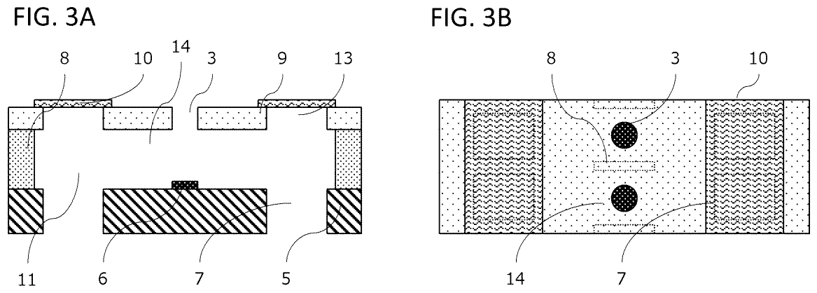

FIGS. 3A and 3B are views for illustrating a position pattern for the flexible member 10 in the layer direction of the orifice plate 2 according to a first embodiment. FIG. 3A is an enlarged view of a substrate upper part, and FIG. 3B is a plan view of the substrate. The energy generation element 6 that generates energy for ejecting liquid stored in the pressure chamber 14 through the ejection port 3 is provided on the surface of the substrate 5. The energy generation element 6 has for example a thermoelectric conversion element or a piezoelectric element. For example, wirings (not shown) for driving the energy generation element 6 may also be provided on the surface of the substrate 5. The energy generation element 6 and the pressure chamber 14 are formed corresponding to the position of the ejection port 3. The orifice plate 2 is composed of the first resin layer 8 and the second resin layer 9 and has the liquid flow path 11 in communication with the ejection port 3. The substrate 5 includes a liquid supply port 7 for supplying ink for example to the liquid flow path 11. In the illustrated example, a first row of the liquid supply ports and a second row of the liquid supply ports are provided with a row of the energy generation elements 6 sandwiched therebetween. Two liquid supply ports 7 provided in the liquid chamber may respectively serve as the inlet side to the liquid chamber and the outlet side from the liquid chamber.

Also according to the embodiment, as shown in FIG. 3A, the second resin layer 9 is provided with an opening 13 corresponding to the liquid supply port 7. A flexible member 10 is provided in a position overlapping the opening 13 in the stacking direction of the substrate 5 and the orifice plate 2. As shown in FIG. 3B, the flexible member 10 is formed across the opening 13 in the direction in which the ejection port 3 is arranged. The phrase “the flexible member 10 overlaps with the liquid supply port 7 in the stacking direction” does not necessarily mean that the flexible member 10 must completely cover the entire liquid supply port 7, and it is sufficient if at least part of the liquid supply port 7 is covered. In the illustrated example, a first strip-shaped flexible member is provided to corresponding to the first row of liquid supply ports, and a second strip-shaped flexible member is provided corresponding to the second row of liquid supply ports.

The method for bonding the second resin layer 9 and the flexible member 10 is not limited to any specific method, and for example, an adhesive may be used for joining them. The opening 13 is a different opening from the ejection port 3 and is formed to penetrate the orifice plate 2. To prevent liquid from leaking to the outside through the opening 13, the flexible member 10 must be secured and arranged to seal the opening 13.

When the energy generation element 6 is driven to eject liquid in this configuration, a pressure wave is generated around the energy generation element 6. As the pressure wave spreads from the pressure chamber 14 to other regions, the flexible member 10 provided at the opening 13 deforms, which is expected to attenuate the pressure wave. At the time, if the flexible member 10 is a strong rigidity, it may be difficult for the member to deform, and a functionally necessary element such as the orifice plate 2 may vibrate, which may affect the ejection characteristic. Therefore, it is preferable to reduce the strength of the flexible member 10 to make it easier to deform, and a material with a lower Young's modulus than those of the first resin layer 8 and the second resin layer 9 is selected. The thickness of the orifice plate 2 in the layer direction is set smaller than the first resin layer 8 and the second resin layer 9. In this way, the strength of the flexible member 10 is set to be smaller than that of the orifice plate 2, allowing the flexible member 10 to deform more easily.

In order to suppress stress generated during the expansion and contraction of various members due to thermal load, a resin layer is used for the flexible member 10. The material for the resin layer of the flexible member 10 may include, for example, but not limited to, polyimide resin and epoxy resin. In addition, the linear expansion coefficient of the flexible member 10 is preferably close to the linear expansion coefficients of the first resin layer 8 and the second resin layer 9. Specifically, the difference in the linear expansion coefficient between the flexible member 10 and the first resin layer 8 and the second resin layer 9 is preferably within 15×10⁻⁶. If, for example, an epoxy resin with a linear expansion coefficient of 55×10⁻⁶ is selected for the first resin layer 8 and the second resin layer 9, it is preferable to select a similar epoxy resin or a resin with a linear expansion coefficient of 40×10⁻⁶ to 70×10⁻⁶. In this way, a recording element substrate with a high vibration suppression effect that has reduced detachment of the flexible member 10 can be provided.

### Modification

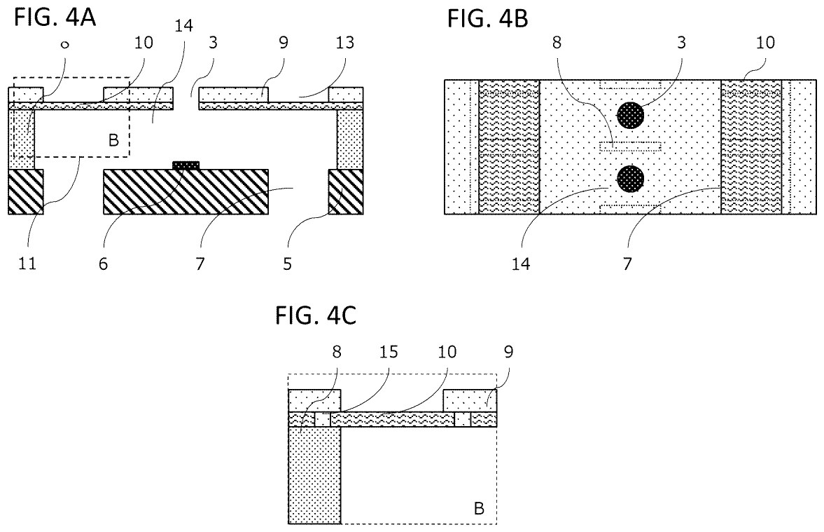

FIGS. 4A and 4B illustrate a modification of the above. FIG. 4A is an enlarged view of the substrate upper part, and FIG. 4B is a plan view of the substrate. In this configuration, the flexible member 10 has a part fixed as it is sandwiched between the first resin layer 8 and the second resin layer 9. A part of the flexible member 10 is formed to cover the first resin layer 8.

In the above-described configuration, when the substrate deforms in a concave direction, compressive stress is generated, and there is no issue with the adhesion between the flexible member 10 and the orifice plate 2, but when the substrate deforms in a convex direction, tensile stress is generated, and there may be an issue with adhesion. As illustrated, when sandwiched between the first and second resin layers 8 and 9, the flexible member 10 becomes strong against deformation both in the concave and convex directions, and the detachment of the flexible member 10 can be suppressed.

As shown in FIG. 4C, it is also suitable to provide a through-hole 15 in the flexible member 10. In this configuration, the first resin layer 8 and the second resin layer 9 are bonded through the through-hole 15, so the adhesion can be further improved.

### Second Embodiment

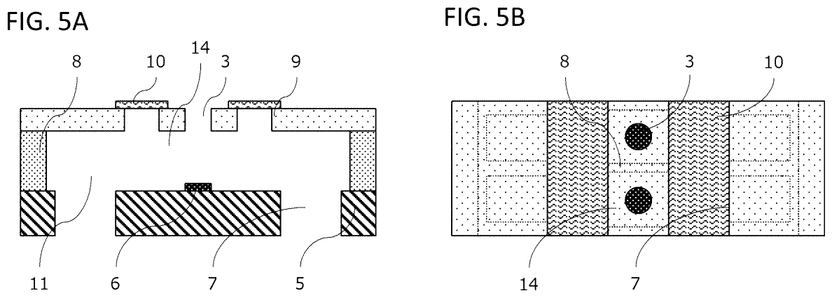

A second embodiment will be described, focusing on the parts different from the first embodiment. FIGS. 5A and 5B show a position pattern for the flexible member 10 in the plane direction of the recording element substrate 1 according to the embodiment. FIG. 5A is an enlarged view of a substrate upper part, and FIG. 5B is a plan view of the substrate. According to the first embodiment, the flexible member 10 is formed on the opening of the liquid supply port 7, but according to the present embodiment, the flexible member 10 forms the opening on the area that overlaps the pressure chamber 14 in the stacking direction, as shown in FIGS. 5A and 5B. Here, when liquid is ejected, a large pressure wave is generated around the energy generation element 6. Therefore, the flexible member 10, when placed near the pressure chamber 14, is expected to attenuate the large pressure wave. According to the embodiment, the flexible member 10 may be formed on the overlapping area of the passage (either the outlet or inlet) from the liquid flow path 11 to the pressure chamber 14 in the stacking direction.

### Modification

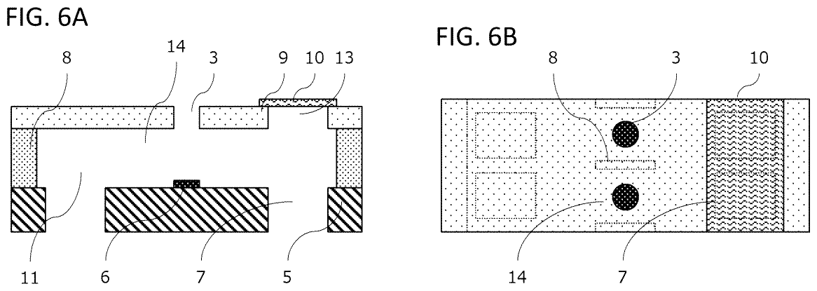

FIGS. 6A and 6B illustrate a modification of the above. FIG. 6A is an enlarged view of a substrate upper part, and FIG. 6B is a plan view of the substrate. As illustrated, with respect to the row of ejection ports 3 as an axis, the flexible member 10 may be provided on the liquid supply ports 7 only on one side. Here, in a configuration in which liquid circulates in a steady flow, the influence of the pressure wave may concentrate at specific locations. In such cases, forming the flexible member 10 only at the locations affected can still provide a sufficient vibration suppression effect.

### Third Embodiment

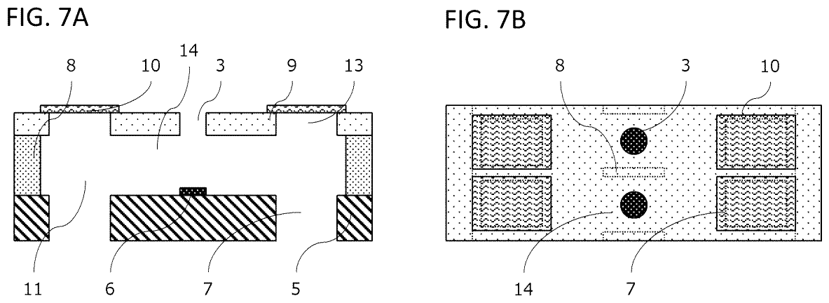

FIGS. 7A and 7B illustrate a shape pattern for the flexible member 10 according to the embodiment. FIG. 7A is an enlarged view of a substrate upper part, FIG. 7B is a plan view of the substrate. As shown in FIGS. 3A and 3B, since the ejection ports 3 are arranged in a row according to the first embodiment, the liquid supply ports 7 are also formed in a row. The flexible member 10 is formed in a strip shape along the row of the liquid supply ports 7. In the configuration according to the first embodiment, thermal load may increase the effect of expansion/contraction, which may increase stress. Therefore, according to the embodiment, as shown in FIGS. 7A and 7B, individual flexible members 10 are provided corresponding to the opening 13 of the second resin layer 9.

### Modification

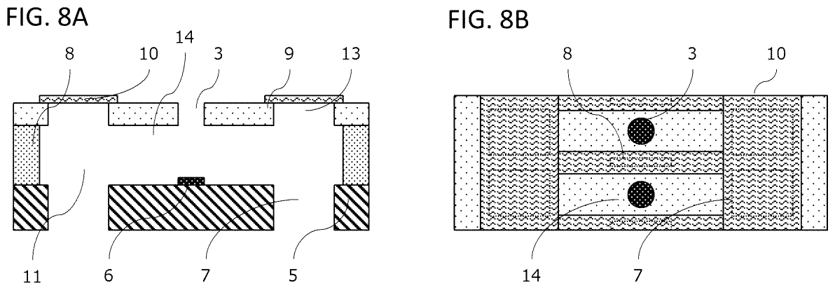

FIGS. 8A and 8B show the configuration of flexible members 10 according to a modification of the above. FIG. 8A is an enlarged view of a substrate upper part, and FIG. 8B is a plan view of the substrate. In this configuration, two flexible members 10 are arranged opposed to each other with respect to the row of ejection ports 3 as an axis and connected by a flexible member for connection. For example, if the strengths of the flexible members 10 and the orifice plate 2, particularly the second resin layer 9, are close, both may deform due to pressure wave. In such a case, the strength of the orifice plate 2 can be increased by connecting the flexible members 10.

### Fourth Embodiment

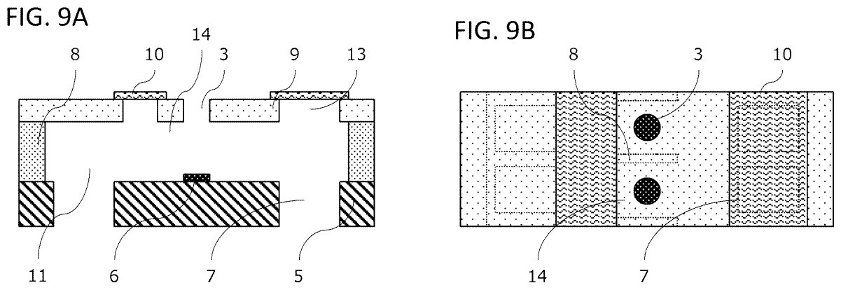

FIGS. 9A and 9B show an example of a combination pattern for the flexible member 10. FIG. 9A is an enlarged view of a substrate upper part, and FIG. 9B is a plan view of the substrate. In this example, the flexible member 10 on the right side in the sheet is arranged to overlap the liquid supply port 7 in the stacking direction of the substrate 5 and the orifice plate 2. Meanwhile, the flexible member 10 on the left side in the sheet is arranged on the inlet/outlet of the pressure chamber 14 in the stacking direction. In this way, the methods for arranging the flexible member 10 according to the above-described embodiments may be arbitrarily combined for each location.

### First Example

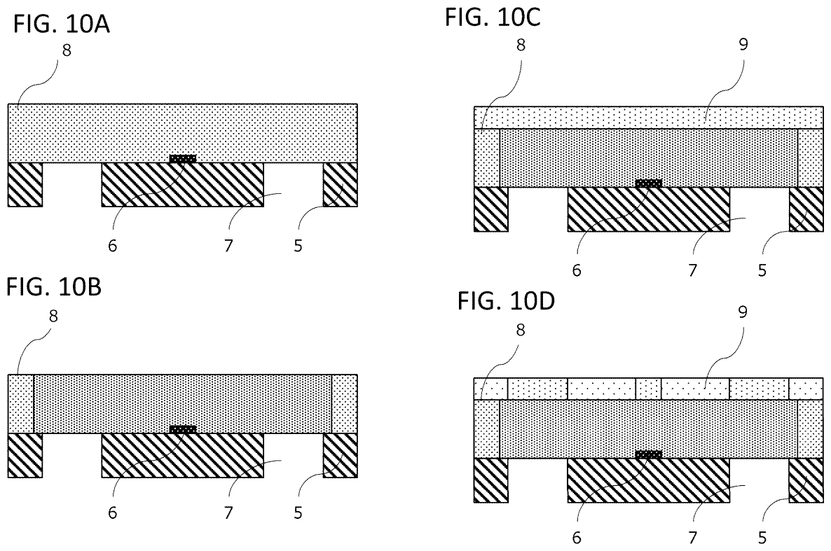

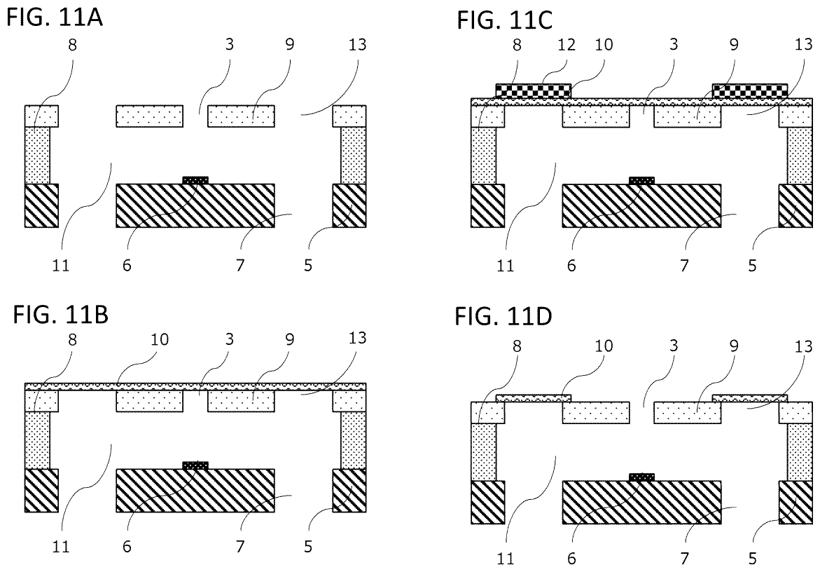

The manufacturing steps for the recording element substrate 1 according to a first example will be described. FIGS. 10A to 11D illustrate the manufacturing steps for the recording element substrate 1 shown in FIGS. 3A and 3B.

As shown in FIG. 10A, the substrate 5 having the energy generation element 6 was subjected to silicon etching using photoresist as a mask and the liquid supply port 7 was formed. Then, the first resin layer 8 was formed by lamination. The first resin layer 8 was formed using a negative-type photosensitive epoxy resin to have a thickness of 15 μm. Then, as shown in FIG. 10B, the first resin layer 8 was exposed to light to pattern the area defining the liquid flow path 11.

Next, as shown in FIG. 10C, the second resin layer 9 was formed on the first resin layer 8 to have a thickness of 10 μm. The second resin layer 9 was made of a negative-type photosensitive epoxy resin and had a sensitivity different from that of the first resin layer 8. The second resin layer 9 can be formed by, for example, but not limited to, lamination or spin coating. Then, as shown in FIG. 10D, the second resin layer 9 was exposed to light to pattern the area that defines the liquid flow path 11, the ejection port 3, and the opening 13. After the exposure, the unexposed parts of the first resin layer 8 and the second resin layer 9 were removed to complete the patterning (FIG. 11A).

After the patterning, the flexible member 10 was formed as shown in FIG. 11B. The flexible member 10 was made of polyimide resin as a material and formed to have a thickness of 3 μm by lamination. Next, as shown in FIG. 11C, the mask resist 12 was formed and patterned to conform to the opening 13. Finally, after dry etching the mask resist 12, wet processing was performed to complete the patterning of the flexible member 10 (FIG. 11D). Note that, although patterning was performed by dry etching in the first example, negative photosensitive resin may be used for the flexible member 10 and patterning by photolithography may be performed.

The recording element substrate 1 produced as described above was able to attenuate the pressure wave during liquid ejection and had improved durability under the thermal load. According to the present invention, a liquid ejection head with a high vibration suppression effect and improved reliability can be provided.

### Second Example

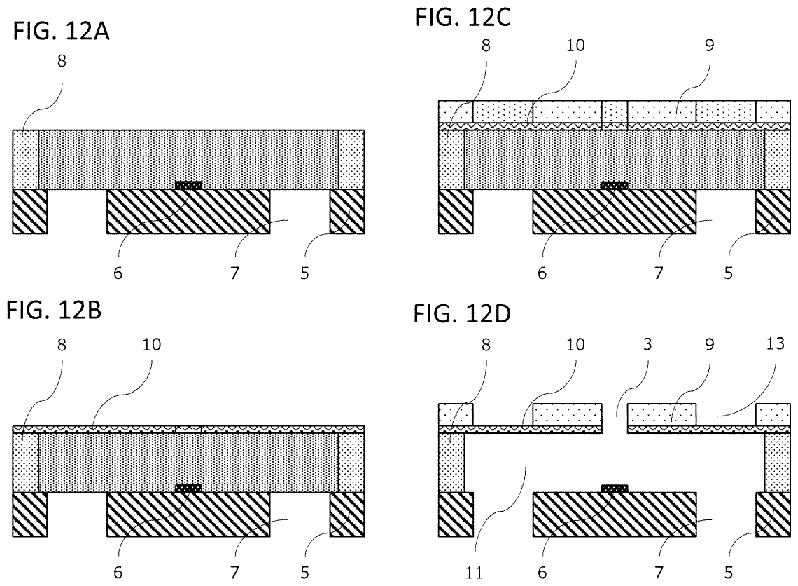

FIG. 12A to 12D illustrate manufacturing steps for the recording element substrate 1 shown in FIGS. 4A and 4B according to a modification of the first embodiment. Only the parts of the second example different from the first example will be described.

As shown in FIG. 12A, the first resin layer 8 was exposed to light in order to pattern the area defining the liquid flow path 11. Then, as shown in FIG. 12B, the flexible member 10 was laminated on the first resin layer 8, and the areas defining the liquid flow path 11 and the ejection port 3 were exposed to light. Then, as shown in FIG. 12C, the second resin layer 9 was laminated on the flexible member 10, and the areas defining the ejection port 3 and the opening 13 were exposed to light. Finally, as shown in FIG. 12D, the unexposed parts of the first resin layer 8, the second resin layer 9, and the flexible member 10 were removed to complete the patterning.

The recording element substrate 1, produced as described above, had further improved durability under the thermal load. According to the present invention, a liquid ejection head with a high vibration suppression effect and improved reliability can be provided. Even when manufacturing the recording element substrate 1 according to any of the other embodiments, it is possible to produce a recording element substrate 1 with a preferable characteristic by combining known methods according to each configuration.

### Applications

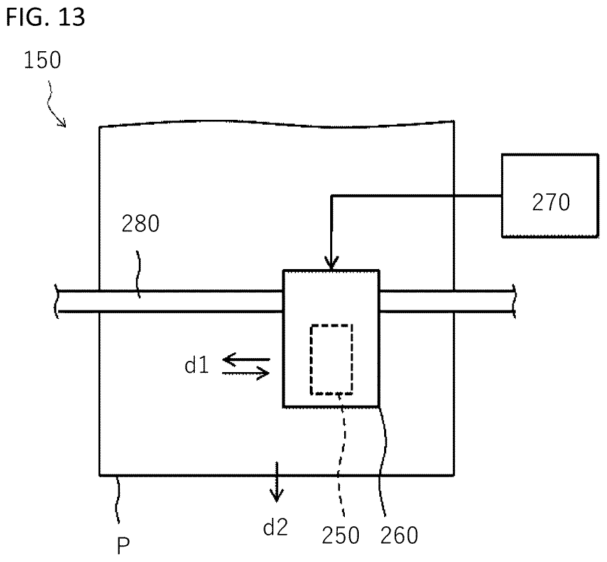

An example of applying the recording element substrate 1 according to the above embodiment to a liquid ejection head or a liquid ejection device will be described. FIG. 13 is a schematic view of an exemplary configuration of an inject-type liquid ejection device 150 (recording device). The liquid ejection device 150 includes a liquid ejection head 250 (recording head), a carriage 260, and a controller 270 that controls driving of these elements.

The liquid ejection head 250 includes a substrate (recording element substrate 1) provided with multiple ejection ports 3 (nozzles) for ejecting liquid such as ink and multiple energy generation elements corresponding to the ejection ports. When the liquid ejection head 250 drives each individual heat generation element in response to a control signal from the controller 270, the liquid in the pressure chamber 14 is heated and ejected from the ejection port 3. In this way, recording (image forming) is performed on a recording medium P such as paper.

The carriage 260 that supports the liquid ejection head 250 is reciprocated along a guide 280 in the direction of the arrow d1 in response to a control signal from the controller 270. The recording medium P is transported in the direction d2 by a transport mechanism included in the liquid ejection device 150. The controller 270 controls the driving of the liquid ejection device 250 while reciprocating the carriage 260, thereby allowing a desired image to be recorded on the recording medium P.

The liquid ejection device 150 can be manufactured by mounting the described recording element substrate 1, as in each of the embodiments, onto the liquid ejection head 250. Using the liquid ejection head 250 and the liquid ejection device 150, it is possible to achieve recording with a high vibration suppression effect and improved reliability.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-005107, filed on Jan. 17, 2024, which is hereby incorporated by reference wherein in its entirety.

What is claimed is:

1. A recording element substrate comprising:
a substrate;
an orifice plate stacked on the substrate and having a liquid chamber which stores liquid between the substrate and the orifice plate, the orifice plate having an ejection port for ejecting the liquid in the liquid chamber; and
an energy generation element provided on the substrate and configured to generate energy for ejecting the liquid stored in the liquid chamber, wherein
the orifice plate is provided with an opening which is different from the ejection port, and a flexible member which seals the opening.

2. The recording element substrate according to claim 1, wherein the flexible member has a lower strength than that of the orifice plate.

3. The recording element substrate according to claim 1, wherein the flexible member is composed of a member thinner than the orifice plate.

4. The recording element substrate according to claim 1, wherein the flexible member is composed of a member having a smaller Young's modulus than that of the orifice plate.

5. The recording element substrate according to claim 1, wherein a difference in linear expansion coefficient between the flexible member and the orifice plate is within 15×10⁻⁶.

6. The recording element substrate according to claim 1, wherein
the substrate has a liquid supply port through which the liquid is supplied from outside, and
a liquid flow path configured to supply, to the liquid chamber, the liquid supplied through the liquid supply port is provided between the substrate and the orifice plate.

7. The recording element substrate according to claim 6, wherein the flexible member is provided in a position overlapping the liquid supply port in a stacking direction of the substrate and the orifice plate.

8. The recording element substrate according to claim 7, wherein
the orifice plate has a plurality of the ejection ports arranged in a row, the substrate has a plurality of the liquid supply ports arranged in a row respectively corresponding to the plurality of the ejection ports, and
the flexible member is formed in a strip shape correspondingly to the row of the liquid supply ports.

9. The recording element substrate according to claim 8, wherein
the substrate has a plurality of the energy generation elements arranged in a row in a position corresponding to the row of the ejection ports in the stacking direction,
the substrate is provided with a first row of liquid supply ports, a second row of liquid supply ports, and a row of the energy generation elements sandwiched between the first row and the second row, and
the flexible member includes a first strip-shaped flexible member provided in a position corresponding to the first row of the liquid supply ports and a second strip-shaped flexible member provided in a position corresponding to the second row of the liquid supply ports.

10. The recording element substrate according to claim 9, wherein the first strip-shaped flexible member and the second strip-shaped flexible member are connected by a flexible member for connection.

11. The recording element substrate according to claim 7, wherein
the orifice plate is provided with a plurality of the ejection ports, the substrate is provided with a plurality of the liquid supply ports respectively corresponding to the plurality of ejection ports, and
the flexible member is formed individually correspondingly to each of the plurality of liquid supply ports.

12. The recording element substrate according to claim 6, wherein the flexible member is provided in a position overlapping a path for the liquid from the liquid flow path to the liquid chamber in the stacking direction of the substrate and the orifice plate.

13. The recording element substrate according to claim 12, wherein
the orifice plate is provided with a plurality of the ejection ports in a row, a plurality of the liquid chambers are provided between the substrate and the orifice plate correspondingly to the plurality of the ejection ports respectively, and
the flexible member is formed in a strip shape to correspond to the plurality of the liquid chambers.

14. The recording element substrate according to claim 1, wherein the orifice plate is formed of a first resin layer provided upright on the substrate to form a sidewall, and a second resin layer supported by the first resin layer so as to oppose the substrate, and provided with the ejection port.

15. The recording element substrate according to claim 14, wherein the flexible member is fixed on the second resin layer.

16. The recording element substrate according to claim 14, wherein the flexible member is sandwiched and fixed between the first resin layer and the second resin layer.

17. The recording element substrate according to claim 16, wherein a part, which is sandwiched between the first resin layer and the second resin layer, of the flexible member is provided with a through hole.

18. A liquid ejection device configured to perform recording on a recording medium by ejecting liquid using a recording element substrate, the recording element substrate comprising:
a substrate;
an orifice plate stacked on the substrate and having a liquid chamber which stores liquid between the substrate and the orifice plate, the orifice plate having an ejection port for ejecting the liquid in the liquid chamber; and
an energy generation element provided on the substrate and configured to generate energy for ejecting the liquid stored in the liquid chamber, wherein
the orifice is provided with an opening which is different from the ejection port, and a flexible member which seals the opening.
